(19) United States
(12) Patent Application Publication
(10) Pub. No.: US 2013/0323697 A1
(43) Pub. Date: Dec. 5, 2013

(54) CRYPTOGRAPHIC EDUCATIONAL PUZZLE

(71) Applicant: John H. SHADDUCK, Menlo Park, CA (US)

(72) Inventor: John H. SHADDUCK, Menlo Park, CA (US)

(21) Appl. No.: 13/482,694

(22) Filed: May 29, 2012

(51) Int. Cl. G09B 19/00

(52) U.S. Cl. 434/222

(57) ABSTRACT

Educational puzzle and game comprising a cryptographic object that carries an invisible ciphertext that can transformed to a visible state from its invisible state only in response one or more operations or manipulations. The puzzle-solver or game player can strategize on how to perform operations on the cryptographic object, which in can comprises trial and error methods based on his or her educational or scientific background.

### FIELD OF THE INVENTION

This invention relates to cryptographic puzzle for learning which includes an object carrying a cipher having invisible and visible states.

### SUMMARY OF THE INVENTION

In general, the educational puzzle or game of the present invention comprises a cryptographic object that carries an invisible ciphertext that can transformed to a visible state from its invisible state only in response one or more operations or manipulations. The puzzle-solver or game player must strategize on how to perform operations on the cryptographic object, which in one variation comprises trial and error methods based on his or her educational or scientific background. However, the operations required to render the cipher visible can be based on any number of themes. In a process similar to any scientific inquiry, the puzzle-solver can investigate various forms of applying energy to the cryptographic object, observing an energy-interaction at a surface of the object, observing the object through an energy-altering device and light refracting device, or a combination thereof. Following the step of making the ciphertext visible, the puzzle-solver then still must decrypt the ciphertext which can require skills and knowledge that can be derived from a wide variety of fields of learning.

In one variation, a cryptographic object or puzzle for learning comprises a puzzle body configured to display a cipher message portion having a hidden state and a visible state; wherein the puzzle body is configured to transform between the hidden state and the visible state in response to the application of at least one physical stimulus.

The physical stimulus can be selected from a group consisting of applying thermal energy, cooling, mechanical energy, electrical energy, chemical energy, magnetic energy, optical energy, and a combination thereof. Typically, the stimulus required to display or transform the message portion can be the application of a single stimulus or can be the application of a series of stimuli where the series must be performed in a particular sequence or in any random sequence. However, variations of the devices and methods are aimed at providing a learning experience for the user in performing the stimulus on the object.

In certain variations, the puzzle body is configured to reversibly transform to the hidden state. Alternatively, the transformation can be non-reversible.

As discussed below, variations of the puzzle body can include at least one of a phase changeable material, a shrinkable material and a shape memory polymer, a magnetic responsive material, an ohmically resistive material and a thermochromic material. Variations of the puzzle body can be configured to transform between the hidden state and the visible state in response to immersion in a liquid or gas. In combination or as an alternative, cryptographic object can include at least one terminal for coupling to an electrical source or a terminal for applying liquid, heat, chemicals or other stimulus.

In certain variations, the cipher message portion can be located on the puzzle body using a material selected from the group consisting of a hydrophilic polymer, a hydrophobic polymer, an ultrahydrophobic polymer, oleophobic polymer, oleophilic polymer a porous polymer and a microporous polymer. In combination, or as an alternative, the cipher message can be located on the puzzle body using a material selected from the group consisting of an absorbent material, an osmotic material and a dissolvable material.

The cryptographic objects described herein can include puzzle body having any type of shape. For example the shapes can be selected from the group consisting of a polygonal, spherical, cylindrical, oblong, oblate, conical, pyramid shaped, prism shaped and free-form.

Variations of the cryptographic object can include a fluid reservoir in fluid communication with the cipher message portion such that fluid flow causes transformation between the hidden state and the visible state.

The cryptographic objects described herein can comprise a non-uniform density.

Another variation of a device described herein includes a puzzle for learning. One variation of such a puzzle can include at least one object carrying a ciphertext consisting of an encrypted plaintext, wherein the ciphertext has an initial non-observable state and is transformable into an observable state only by performing a plurality of different operations on the at least one object.

The puzzle described above can also include at least one material that is transformable in response to the addition or subtraction of energy relative to the object. For example the form or energy can be at least one of mechanical energy, electrical energy, chemical energy, light energy, magnetic energy, heating and cooling.

Another variation of a device described herein includes a game apparatus for learning, comprising at least one object carrying first and second ciphers portions, wherein the first cipher portion is convertible from a non-observable state to an observable state by a first user operation and the second cipher is convertible from a non-observable state to an observable state by a second user operation different from the first operation.

The game apparatus can include a material that is convertible from the non-observable state to the observable state in response to the addition or subtraction of energy to or from the at least one object. In some variations the first cipher portion is convertible from a non-observable state by the addition or subtraction of at least two forms of energy. The addition or subtraction of at least two forms of energy required to transform the device can be sequential, random, or contemporaneous.

The present disclosure also includes a learning method comprising: providing at least one object carrying a ciphertext message consisting of an encrypted plaintext, wherein the object is configured to transform the ciphertext message between an initial non-observable state and a second observable state; instructing an individual to perform at least one different physical operation on the at least one object to attempt to transform the cipher; transforming the ciphertext message to the second observable state upon the correct physical operation or sequence of operations.

In one variation, the learning method can further comprise configuring the object to transform the ciphertext message to the second observable state using a physical operation selected from a group consisting of applying thermal energy, cooling, mechanical energy, electrical energy, chemical energy, magnetic energy, optical energy, and a combination thereof.

The learning method can also comprise configuring the object to comprise a puzzle related to a subject matter selected from the group consisting of literature, art, art history, cryptography, history, languages, linguistics, film, performing arts, visual arts, philosophy, religion, anthropology, archaeology, economics, geography, political science, psychology, sociology, space sciences, earth sciences, life sciences, ethnic studies, chemistry, physics, logic, mathematics, statistics, computer sciences, architecture, design, engineering, environmental studies and ecology.

The cryptographic object or puzzle can be used in many educational settings as a tool to teach scientific methods or the puzzle can be marketed as a toy which may be considered to be in the game category similar to a Rubik's cube.

### BRIEF DESCRIPTION OF THE DRAWINGS

The invention as well as a preferred mode of use, further objectives and advantages thereof will be best understood by reference to the following detailed description of an illustrative embodiment when read in conjunction with the accompanying drawings, wherein:

FIG. 1 is a perspective view of a block comprising the cipher puzzle in a first state.

FIG. 2A is an enlarged view of a portion of the block of FIG. 1 with the ciphertext in an invisible state.

FIG. 2B is a view of the portion of the block of FIG. 3A following an operation to alter the ciphertext to a second or visible state.

FIG. 3 is a view of the block of FIG. 1 following an operation to alter the ciphertext in one surface of the block to a second or visible state.

FIG. 4 is a view of the block of FIG. 3 following at least one successive operation to further alter ciphertext is additional block surfaces to the visible state.

FIG. 5A is an enlarged view of another variation of a block similar to that of FIG. 1 with the cipher text in an invisible state.

FIG. 5B is a view of the block of FIG. 5A following an operation to alter a dimension of the cipher text to provide a visible state.

FIG. 6 is a view of an alternative block similar to that of FIG. 1 that included surface portions that comprise electrical terminals.

### DETAILED DESCRIPTION OF THE INVENTION

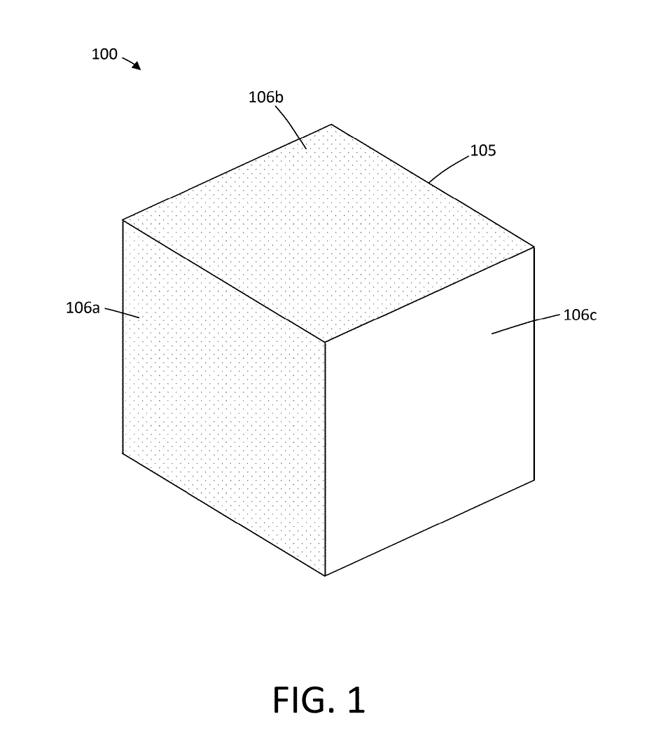

FIG. 1 is a representation of a cryptographic object, puzzle or game apparatus 100 according to one embodiment of the invention. In one variation, the puzzle 100 comprises a single block 105 that can be any 3-dimensional polygonal shape, spherical shape, flat 2-dimensional shape, cylindrical shape, oblong shape, oblate shape, conical shape, pyramidal shape, prism shape or free-form shape (e.g., a moldable shape, or an amorphous shape) that has a one or more portions that carry a cipher or portion of a cipher. The puzzle 100 also can consist of multiple blocks instead of a single block 105 as in FIG. 1. A puzzle also can comprise multiple blocks that are detachable from one another. The block 105 of FIG. 1 is shown as a cube with six sides or portions that each can carry at least one cipher portion. FIG. 1 shows sides 106a, 106b and 106c of the block 105.

In this disclosure, the following terms will be used in describing the puzzle and puzzle-solving operations. The terms cipher or ciphertext are used interchangeably to describe a text on a surface or portion of a surface of the puzzle block 105. The ciphertext, as in known in the art of cryptography, has been converted from plaintext—which is the original information—that has been encrypted into the ciphertext. Thus, the ciphertext message contains the information provided by the plaintext message, but the ciphertext is in a format that is not readable by a human without the proper key to decrypt the message. The ciphertext appears to be random gibberish when viewed. The term key is used herein to describe the mechanism used to decrypt the ciphertext. Any such key known in the art of cryptography can be used. One aspect of the invention relates to the fact that the ciphertext further has visible and invisible states, and the term operation is used herein to describe the step or series of steps that are required to transform or manipulate the ciphertext to a visible state from its hidden or invisible state. It is this aspect of the invention that provides a puzzle for learning, as will be described further below.

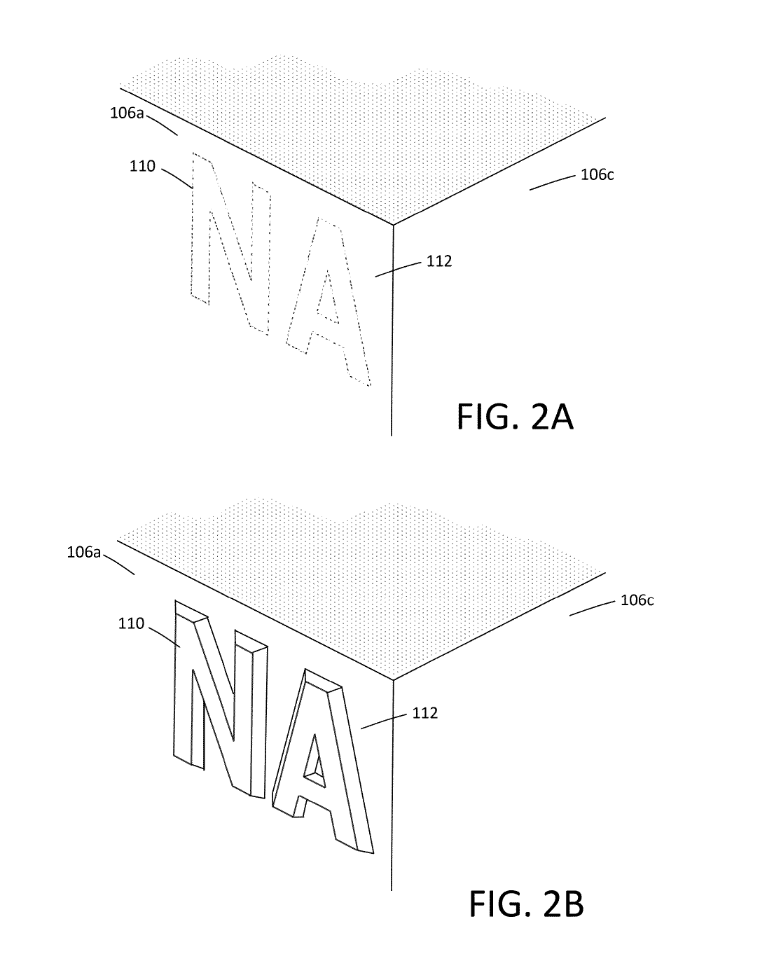

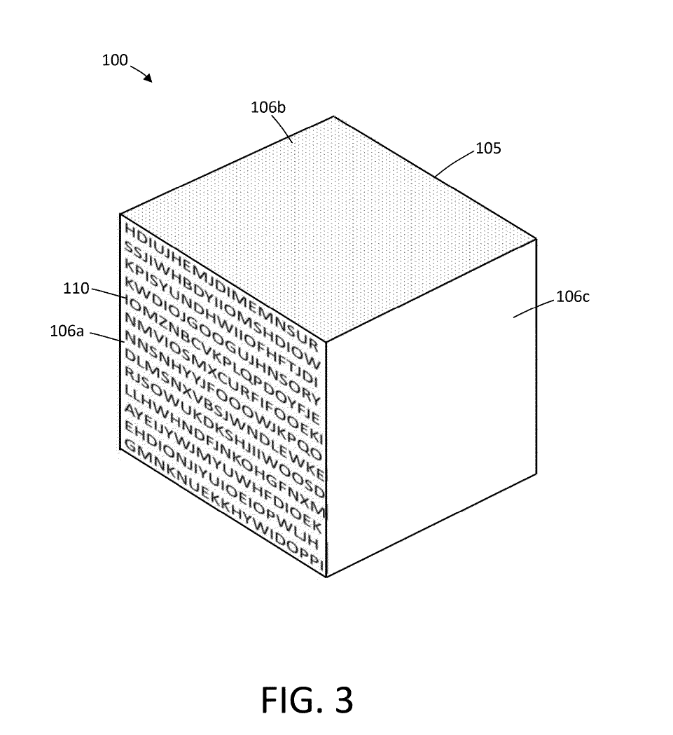

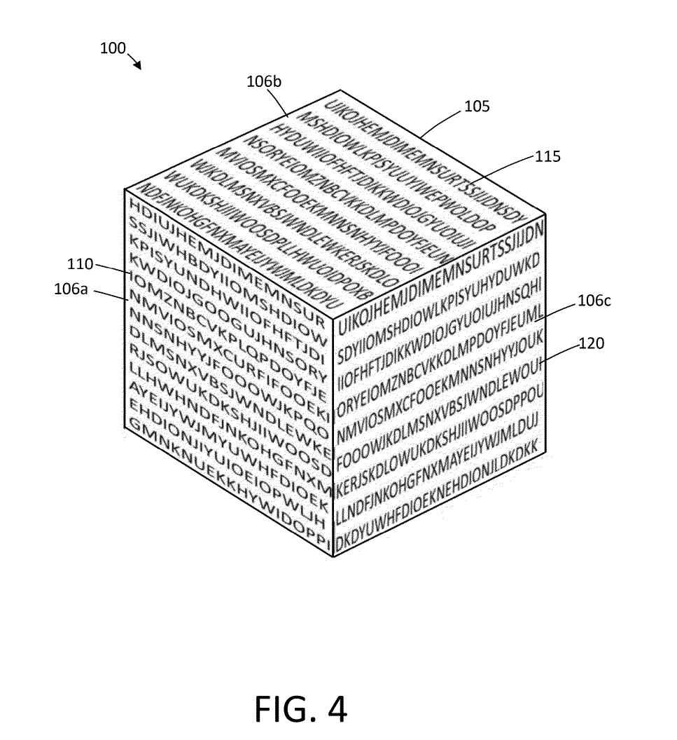

Now turning to FIGS. 1 and 2A-2B, it can be seen that side 106a of the block 105 in FIG. 1 has a smooth surface which contains a ciphertext—however the ciphertext in FIG. 1 is not in a visible state. FIG. 2A shows an enlarged view of a portion of surface 106a with the invisible ciphertext 100 indicated in phantom view. In FIGS. 2B and 3, the ciphertext 110 is made visible relative to field 112 around the ciphertext in one surface 106a of block 105 following an operation or a plurality of operations. In this learning aspect of the puzzle, the observer or puzzle-solver must strategize on what type of operation(s) or manipulation(s) might transform the invisible ciphertext 110 to its visible state. In one aspect of the invention, the operation or manipulation can be related to the fields of physics, mechanics, chemistry, biology or other physical science cause-and-effect relationship and thus the puzzle-solver must base a strategy and experimentation on his or her knowledge of the potential fields that should have been learned in high school, college or other educational endeavors. FIG. 4 depicts the block 105 wherein ciphertext 115 in surfaces 106b and ciphertext 120 on surface 106c have been manipulated to the visible state following a plurality of operations.

Following the successful step or steps of making the ciphertext entirely visible as depicted in FIG. 4, the puzzle-solver must then decrypt the ciphertext into plaintext to solve the puzzle by discovering or developing a key as is known the art of cryptography. The subject matter contained within the cipher provides a further opportunity for application of the puzzle-solvers educational background and expertise. For example, the subject matter can involve a puzzle relating to literature, art, art history, cryptography, history, languages, linguistics, film, performing arts, visual arts, philosophy, religion, anthropology, archaeology, economics, geography, political science, psychology, sociology, space sciences, earth sciences, life sciences, ethnic studies, chemistry, physics, logic, mathematics, statistics, computer sciences, architecture, design, engineering, environmental studies, ecology or other field.

In general, the puzzle or cryptographic object in one embodiment is configured with at least one ciphertext that is transformable to a visible state from an invisible state in response to at least one operation selected from the group consisting of applying a form of energy to the object, observing an energy-interaction at a surface of the object, observing the object through an energy-altering device or light refracting device, or a combination thereof. The form of applied energy can be selected from the group of applying thermal energy to the object, cooling the object, applying mechanical energy to the object, applying electrical energy to the object, applying chemical energy to the object, applying magnetic energy to the object and/or applying light energy to the object. The operation may transform the ciphertext 110 or the field 112 (see FIGS. 2A, 2B and 3) around the ciphertext to thus make the cipher visible.

In one embodiment of cryptographic object, the visible state of the ciphertext can be permanent. In another embodiment of cryptographic object, the visible state of the ciphertext can temporary.

Operations utilizing applied thermal energy. In one example of a cryptographic object that provides a ciphertext with a temporary visible state, the ciphertext can comprises a thermochromic material within a surface of the object 105 as represented in FIGS. 1 and 2A. Thermochromatic materials are well-known and can comprise a liquid crystal that is capable of displaying different colors at different temperatures. The color change is dependent on selective reflection of certain wavelengths by the crystallic structure of the material, as it changes between the material's low-temperature crystal phase and the material's high-temperature isotropic liquid phase. Light passing through the crystal undergoes Bragg diffraction in the material and the wavelength with the greatest constructive interference is reflected back, which is perceived as a spectral color. A change in the crystal temperature can thus result in a change in the reflected wavelength. The color of a thermochromic liquid crystal can range from a non-reflective black through the spectral colors to black again, depending on the temperature.

In another variation represented by FIGS. 1, 2A-2B and 3, the block 105 and at least the surface 106a comprises an elastomeric shape memory polymer (SMP) that has ciphertext letters configured to have a raised or visible memory shape (FIG. 2B) and that also has a temporary equilibrium compacted shape (FIG. 2A) to make the ciphertext non-visible. In other words, the temporary shape is flattened in surface 106a.

As background, one type of shape memory polymer demonstrates the phenomena of shape memory based on fabricating a segregated linear block co-polymer, typically of a hard segment and a soft segment. The shape memory polymer generally is characterized as defining phases that result from glass transition temperatures (T_{g}) in the hard and soft segments or other types of phase change. The hard segment of SMP typically is crystalline with a defined melting point, and the soft segment is typically amorphous, with another defined transition temperature. In some embodiments, these characteristics may be reversed together with the segment's glass transition temperatures. In one embodiment, the SMPs that are suitable for the puzzle can comprise a subset of shape memory polymer materials that comprises an open-cell foam polymer. Either simple elastomeric or open-cell foam SMPs can be used for the temporary and memory shapes of the ciphertext.

Referring to FIGS. 2A-2B, the SMP ciphertext 110 can be fabricated to the indicated memory shape of FIG. 2B. In such an embodiment, when the SMP material is elevated in temperature above the melting point or glass transition temperature of the hard segment, the material is then formed into its memory shape. The selected shape is memorized by cooling the SMP below the melting point or glass transition temperature of the hard segment. When the shaped SMP is cooled below the melting point or glass transition temperature of the soft segment while the shape is deformed, that temporary shape is fixed. The temporary shape can be a highly compacted or flattened shape as shown in FIG. 2A.

The original memory shape then can be recovered by heating the material above the melting point or glass transition temperature T_{g} of the soft segment but below the melting point or glass transition temperature of the hard segment. (Other methods for setting temporary and memory shapes are known which are described in the literature below). The recovery of the original memory shape is thus induced by an increase in temperature, and is termed the thermal shape memory effect of the polymer. The transition temperature can be any suitable temperature, for example from about 50° C. to 100° C. The operation of heating the surface 106a can be accomplished by heating in an oven, by immersing the block 105 in hot water or any other suitable heating method.

After the puzzle-solver determines that heating is the correct operation to transform the ciphertext 110 to its visible state, then another key as known in cryptography needs to be used to decrypt the cipher.

Besides utilizing the dimensional shape memory effect of the polymer, other memorized physical properties of the SMP component of the block 105 can be controlled by its change in temperature or stress, particularly in ranges of the melting point or glass transition temperature of the soft segment of the polymer, e.g., the elastic modulus, hardness, flexibility, permeability and index of refraction. All of these physical properties can be used to develop ciphertext that has an invisible state. Examples of polymers that have been utilized in hard and soft segments of SMPs include polyurethanes, polynorborenes, styrene-butadiene co-polymers, cross-linked polyethylenes, cross-linked polycyclooctenes, polyethers, polyacrylates, polyamides, polysiloxanes, polyether amides, polyether esters, and urethane-butadiene co-polymers and others identified in the following patents and publications: U.S. Pat. No. 5,145,935 to Hayashi; U.S. Pat. No. 5,506,300 to Ward et al.; U.S. Pat. No. 5,665,822 to Bitler et al.; and U.S. Pat. No. 6,388,043 to Langer et al. (all of which are incorporated herein by reference); Mather, Strain Recovery in POSS Hybrid Thermoplastics, Polymer 2000, 41(1), 528; Mather et al., Shape Memory and Nanostructure in Poly(Norbonyl-POSS) Copolymers, Polym. Int. 49, 453-57 (2000); Lui et al., Thermomechanical Characterization of a Tailored Series of Shape Memory Polymers, J. App. Med. Plastics, Fall 2002; Gorden, Applications of Shape Memory Polyurethanes, Proceedings of the First International Conference on Shape Memory and Superelastic Technologies, SMST International Committee, pp. 120-19 (1994); Kim, et al., Polyurethanes having shape memory effect, Polymer 37(26):5781-93 (1996); Li et al., Crystallinity and morphology of segmented polyurethanes with different soft-segment length, J. Applied Polymer 62:631-38 (1996); Takahashi et al., Structure and properties of shape-memory polyurethane block copolymers, J. Applied Polymer Science 60:1061-69 (1996); Tobushi H., et al., Thermomechanical properties of shape memory polymers of polyurethane series and their applications, J. Physique IV (Colloque CI) 6:377-84 (1996)) (all of the cited literature incorporated herein by this reference). The above background materials, in general, describe SMP in a non-open cell solid form. The similar set of polymers can be foamed, or can be microfabricated with an open cell structure for use in the invention.

In another embodiment, the transition temperature can be selected and a remote source can be used to elevate the temperature and expand the SMP structure to its memory shape, for example, by coupling electrical energy to a resistively or inductively heatable material in the SMP.

In one embodiment, a shape memory polymer foam can be used wherein the memory shape can have a open cell configuration and the temporary shape can have a closed cell configuration. Such a foam SMP can be a polyurethane-based thermoplastic that can be engineered with a wide range of glass transition temperatures. These SMP foams possess several potential advantages for the invention, for example: very large shape recovery strains are achievable, e.g., a substantially large reversible reduction of the Young's Modulus in the material's rubbery state; the material's ability to undergo reversible inelastic strains of greater than 10%, and preferably greater that 20% and still more preferably greater that about 100; shape recovery can be designed at a selected temperature between about 50° C. and 100° C. Since the polymers can exhibit unique properties in terms of capacity to alter the material's water or fluid permeability, the ciphertext (or the field around the ciphertext) can comprise a foam SMP that can be thermally stimulated to an open cell state and thus can absorb a liquid or dye to distinguish the ciphertext from the background field to make the ciphertext visible, which can be temporary or permanent.

Operations utilizing combination of thermal energy and light refraction. In another variation, which can be understood from FIGS. 1-4, the ciphertext can be microfabricated of a shape memory polymer using soft lithography techniques to function as described above. In addition stimulating the SMP to transform the invisible ciphertext to a visible state, the puzzle-solver would need to observe the visible ciphertext with magnification means, such as a magnifying glass. The SMP structure can be microfabricated of a resilient polymer (e.g., silicone) by several different techniques—all collectively known as soft lithography. For example, microtransfer molding is used wherein a transparent, elastomeric polydimethylsiloxane (PDMS) stamp has patterned relief on its surface to generate features in the polymer. The PDMS stamp is filled with a prepolymer or ceramic precursor and placed on a substrate. The material is cured and the stamp is removed. The technique generates features as small as 250 nm. Replica molding is a similar process wherein a PDMS stamp is cast against a conventionally patterned master. A polyurethane or other polymer is then molded against the secondary PDMS master. In this way, multiple copies can be made without damaging the original master. The technique can replicate features as small as 30 nm. Another process is known as micromolding in capillaries (MIMIC) wherein continuous channels are formed when a PDMS stamp is brought into conformal contact with a solid substrate. Then, capillary action tills the channels with a polymer precursor. The polymer is cured and the stamp is removed. MIMIC can generate features down to 1 μm in size. Solvent-assisted microcontact molding (SAMIM) is also known wherein a small amount of solvent is spread on a patterned PDMS stamp and the stamp is placed on a polymer, such as photoresist. The solvent swells the polymer and causes it to expand to fill the surface relief of the stamp. Features as small as 60 nm have been produced (see Xia and Whitesides, Annu. Rev. Mater. Sci. 1998 28:153-84).

Operations utilizing surface energy effects. In another embodiment, the SMP or SMP foam can change a material property of the ciphertext 110 or field 112 of the block 105 relative to one another, for example, by changing the hydrophobic characteristics, hydrophilic characteristics, oleophobic characteristics or oleophilic characteristics of the ciphertext 110 or field 112. In order to make the ciphertext visible, the puzzle-solver can immerse a surface 106a of the block with water, oil or another suitable fluid and observe the fluid behavior as it is attracted to or repelled from the surface of the ciphertext or field thus making it ciphertext visible.

Operations utilizing applied mechanical energy. In another embodiment, the ciphertext 110 can be formed of a polymer or other material that is harder or less prone to abrasion than the material of field 112, or vice versa. An operation to make the ciphertext visible can comprise sanding, abrading, sandblasting or the like to alter or remove a surface portion of ciphertext or field to make the ciphertext visible. In other words, the ciphertext can be made visible by application of mechanical energy to the object.

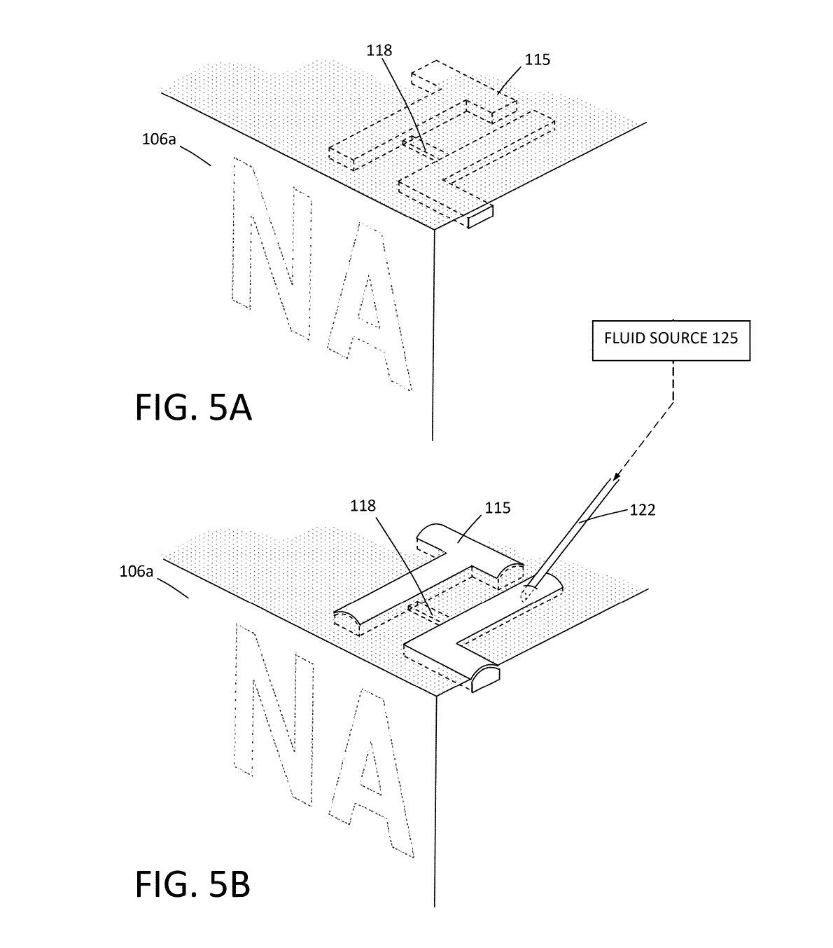

In another variation shown in FIGS. 5A and 5B, the ciphertext can comprise channels that form the text 115 that includes interconnected fluidic channels 118 that can receive a flowable media that can be injected into such channels and allowed to migrate through the channels to expose the ciphertext. In FIG. 5B, it can be seen that a needle 122 and fluid source 125 can be used to inject fluid into the fluidic channels to cause an elastomeric surface to be raised to make the cipertext 115 visible. The block can include a visual clue as to a proper location to inject a fluid (liquid or gas) and a pressure relief port may be provided to allow rapid fluid migration through the channels of network of channels. In a related variation, a dye may be injected into the microchannels to make the network comprising the ciphertext visible.

In another variation, a first polymer comprises the ciphertext 110 and a second polymer comprises the field 112 (cf. FIGS. 1-4) and in a first state, both polymers are similar and in appearance comprise a transparent or translucent material. Either the first or second polymer carries a volume of fracturable dye-filled microspheres. In this variation, the puzzle-solver can apply a form of mechanical force to fracture the microspheres which in turn can change the color of the ciphertext 110 or field 112. For example, the block can be impacted with a hammer or can be dropped or thrown to develop sufficient g-forces upon impact to fracture the microspheres. In one variation, the first polymer of the ciphertext 110 which carries the microspheres can be slightly porous and the second polymer of the field 112 can be impervious to fluid absorption to thus allow the dye of the fractured microspheres to diffuse through the first polymer and create a distinct interface between the first and second polymers. In another embodiment, the block can contain single or multiple fluid reservoirs that can be fractured or disrupted to permit a dye to migrate within channels, microchannels or porous pathways to color the ciphertext or field.

Operations utilizing chemical energy effects. In another embodiment, either the ciphertext 110 or field 112 of block 105 (cf. FIGS. 1-4) can be formed of a polymer or other material that is slightly erodible or dissolvable, thus providing a ciphertext that can be made visible in a chemical energy interaction. The dissolving agent can be any suitable material, for example, a weak acid such vinegar, water, heated water or the like. The time interval for such dissolution or erosion of the block material can range from instantaneous upon contact with a chemical agent to 24 hours or more. In another embodiment, the ciphertext or field can be made visible by a combination of chemical and mechanical operations initiated by the puzzle-solver. For example, the block 105 can contain reservoirs with chemical reactants configured for chemiluminescence. Chemiluminescence is the generation of electromagnetic radiation as light by the release of energy from a chemical reaction. The reaction can emit visible light, but other wavelengths are possible in the ultraviolet or infrared regions. Luminol is one chemical that exhibits chemiluminescence with a blue glow when mixed with an appropriate oxidizing agent such as hydrogen peroxide. In one variation, the ciphertext can be can comprise fluid microchannels in which the reactants intermix and emit light to make the text visible. In another variation, the oxidizing agent can be introduced into a target interior reservoir in the block 105 from an external source to trigger chemiluminescence. The external source can a syringe which can be penetrated through a elastomeric portal in the block to access the target reservoir. In general, the object or block 105 can be configured to transform to the visible state form the invisible state in response to immersion in a liquid or gas.

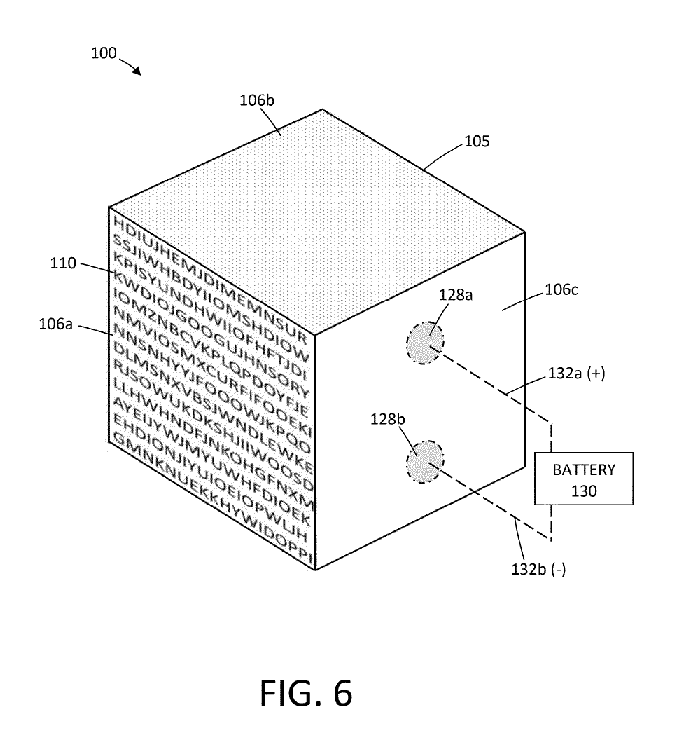

Operations utilizing applied electrical energy. In another related variation, the ciphertext 110 can comprise electrically conductive materials such as a conductively doped polymer that forms at least one electrical circuit embedded in the block. In one variation, the electrical circuit can comprise an electroluminescent wire, such as a thin copper wire coated in a phosphor which glows when an alternating current is applied to the wire. The electroluminescent wire can be formed into a ciphertext and embedded in a thin layer of translucent polymer which prevents observation of the wire itself but permits light transmission when current is applied to the electroluminescent wire. In one variation shown in FIG. 6 that utilizes electrical energy in an operation, the surface of the cryptographic object can include at least one electrically conductive surface portion or electrical terminals 128a, 128b for coupling to an electrical source, for example to leads 132a, 132b that extend to a battery 140.

Operations utilizing applied magnetic energy. In another related variation, the ciphertext 110 can comprise a magnetic responsive material such as a polymer embedded with magnetic particles. In use, a magnetic field can be applied to the magnetic responsive material which can interact with and localize magnetic responsive powder about the surface of the block to thus distinguish the ciphertext region from the field.

Operations utilizing combinations of applied energy. In another related variation, the ciphertext 110 can comprise a changeable polymeric material in the block surface that changes a perceivable parameter (e.g., color, dimension, texture, opacity, hydrophobicity, etc.) upon exposure to a fluid in the interior of the block. In one variation, an interior chamber in the block can carry a fluid in interior microchannels to the a changeable polymeric material to cause such material to be altered to a visible state. The interior chamber can be fractured by hammering on the block or generally applying sufficient G-forces to the block by any suitable means. In another variation, the block can be configured with invisible microchannels in a somewhat translucent block surface, and the microchannels themselves can form text that can be made visible when an ink migrated through the microchannels from a fracturable interior chamber. In another variation, the interior chamber in the block that carries a dye or chemically reactive fluid can be configured with a sacrificial port or valve that can be sacrificed by thermal effects or the application of electrical energy. In general, the puzzle or game apparatus comprises material that is convertible from the non-observable state to the observable state in response to the addition or subtraction of energy to or from the at least one object. In one variation, a cipher portion can be convertible from a non-observable state by the addition or subtraction of at least two forms of energy. Further, the addition or subtraction of at least two forms of energy can be sequential or contemporaneous.

In another aspect of the invention, the cipher or a portion or a cipher in the block 105 can direct the user to an expanded cipher, or series or ciphers, in one or more other media sources such as an internet site, a book, a newspaper or other publication. In this respect, the complexity of the cipher and game can be greatly expanded. Text messages or phone messages can also be used to provide an expanded cipher or series of ciphers. The puzzle then can have multiple layers as a means of increasing the challenge of solving the puzzle.

In a method of the invention, the cryptographic object or objects can be commercialized and can offer a prize or award to the first puzzle-solver to decrypt the ciphertext or a portion of the ciphertext. In another variation, the method can include using the internet or social media to assist the potential puzzle-solvers in the process of determining which operations may be useful in making the ciphertext visible and/or in finding key to decrypt the ciphertext. In another method, the cipher when solved can introduce the puzzle-solver to one or more additional ciphers that can be found on an internet site. In another method, a decrypted cipher can lead the puzzle-solver to a geographic location (instead of an internet location) to find an additional clue for solving the puzzle, or the decrypted cipher can lead the puzzle-solver to an account number at a bank or other institution which may contain an additional clue or a prize. In another method, social networking sites such as YouTube, Facebook, Twitter etc. can be used by the entity commercializing the puzzle to direct the potential puzzle-solvers. Further, the method can include using social media as a means of viral marketing to assist is further commercializing the puzzle. In general, a method can comprise commercializing a cryptographic object configured with ciphertext that is transformable to a visible state from an invisible state in response to at least one operation, providing ciphertext that when decrypted directs to puzzle-solver to an internet site or social media site, and utilizing such social media or internet sites to (i) extend the puzzle, (ii) to provide hints to puzzle-solvers or game players and/or (iii) to market the product virally among users of such social media or internet sites.

In another aspect of the business method of the invention, a series of puzzles can be commercialized with the ciphertext and related operations designed for a selected age group. For example, puzzles may be designed for any particular age group ranging from puzzle-solvers under the age of 10 years, 12 years, 14 years, 16 years, 18 years, 20 years or adults. In another aspect of the business method of the invention, a series of puzzles can be commercialized with the ciphertext and related operations designed for individuals having a selected background in a particular field such as literature, art, art history, cryptography, history, languages, linguistics, film, performing arts, visual arts, philosophy, religion, anthropology, archaeology, economics, geography, political science, psychology, sociology, space sciences, earth sciences, life sciences, ethnic studies, chemistry, physics, logic, mathematics, statistics, computer sciences, architecture, design, engineering, environmental studies, ecology or another field.

While the invention has been described as having ciphertext in the form letters of the alphabet, the term ciphertext should be considered to include all forms and types of alphabets (both ancient and current), scripts, symbols, hieroglyphs, and the like that can yield a decrypted text in any language. Further, the ciphertext can constitute images that may be useful in providing clues to solving the puzzle.

Although particular embodiments of the present invention have been described above in detail, it will be understood that this description is merely for purposes of illustration and the above description of the invention is not exhaustive. Specific features of the invention are shown in some drawings and not in others, and this is for convenience only and any feature may be combined with another in accordance with the invention. A number of variations and alternatives will be apparent to one having ordinary skills in the art. Such alternatives and variations are intended to be included within the scope of the claims. Particular features that are presented in dependent claims can be combined and fall within the scope of the invention. The invention also encompasses embodiments as if dependent claims were alternatively written in a multiple dependent claim format with reference to other independent claims.

1. A cryptographic object for learning, the cryptographic object comprising:
a puzzle body configured to display a cipher message portion having a hidden state and a visible state where the cipher message is encrypted and requires a proper key to convert to a plaintext message;
wherein the puzzle body is configured to transform between the hidden state and the visible state in response to the application of at least one physical stimulus.

2. The cryptographic object of claim 1 wherein the at least one physical stimulus is selected from a group consisting of applying thermal energy, cooling, mechanical energy, electrical energy, chemical energy, magnetic energy, light energy, and a combination thereof.

3. The cryptographic object of claim 1 wherein the puzzle body is configured to reversibly or irreversibly transform to the visible state.

4. The cryptographic object of claim 1 wherein the puzzle body comprises at least one of a phase changeable material, a shrinkable material, a shape memory polymer, a magnetic responsive material, an ohmically resistive material and a thermochromic material.

5. The cryptographic object of claim 1 configured to transform between the hidden state and the visible state in response to immersion in a liquid or gas.

6. The cryptographic object of claim 1 including at least one electrical terminal for coupling to an electrical source.

7. The cryptographic object of claim 1 wherein the cipher message portion is located on the puzzle body using a material selected from the group consisting of a hydrophilic polymer, a hydrophobic polymer, an ultrahydrophobic polymer, oleophobic polymer, oleophilic polymer a porous polymer and a microporous polymer.

8. The cryptographic object of claim 1 wherein the cipher message is located on the puzzle body using a material selected from the group consisting of an absorbent material, an osmotic material and a dissolvable material.

9. The cryptographic object of claim 1 wherein the puzzle body comprises a shape selected from the group consisting of a polygonal, spherical, cylindrical, oblong, oblate, conical, pyramid shaped, prism shaped and free-form.

10. The cryptographic object of claim 1 wherein the object includes a fluid reservoir in fluid communication with the cipher message portion such that fluid flow causes transformation between the hidden state and the visible state.

11. The cryptographic object of claim 1 wherein the object includes an electrical circuit in electrical communication with the cipher message.

12. The cryptographic object of claim 1 wherein the object has non-uniform density.

13. The cryptographic object of claim 1 wherein the object comprises a plurality of puzzle bodies.

14. A learning method comprising:
providing at least one object carrying a ciphertext message consisting of an encrypted plaintext, wherein the object is configured to transform the ciphertext message between an initial non-observable state and a second observable state;
instructing an individual to perform at least one physical operation on the at least one object to attempt to transform the cipher; and
transforming the ciphertext message to the second observable state upon the correct physical operation or sequence of operations.

15. The learning method of claim 14, wherein the instructing step includes remotely providing instructions to the individual electronically.

16. The learning method of claim 15, where remotely providing instructions comprises providing instructions selected from a group consisting of using a text message, a phone call, and an internet page.

17. The learning method of claim 14, wherein the instructing step includes providing a clue relating to either the physical operation or to decrypting the ciphertext.

18. A game apparatus for learning, comprising at least one object carrying first and second ciphers portions, wherein the first cipher portion is convertible from a non-observable state to an observable state by a first user operation and the second cipher is convertible from a non-observable state to an observable state by a second user operation different from the first operation where at least the first cipher portion comprises a cipher message in the observable state, where the cipher message is encrypted and requires a proper key to convert to a plaintext message.

19. The game apparatus of claim 18 wherein the at least one object includes a material that is convertible from the non-observable state to the observable state in response to the addition or subtraction of energy to or from the at least one object.

20. The game apparatus of claim 19 wherein a cipher portion is convertible from the non-observable state by the addition or subtraction of at least two forms of energy.

21. The cryptographic object of claim 1, wherein the puzzle body is configured to transform between the hidden state and the visible state in response to the application of at least a second physical stimulus.

22. The cryptographic object of claim 21, where the puzzle body is configured to transform between the hidden state and the visible state in response to the application of the at least one physical stimulus and the second physical stimulus performed in a particular sequence.
